(19) United States
(12) Patent Application Publication
(10) Pub. No.: US 2023/0169674 A1
(43) Pub. Date: Jun. 1, 2023

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: YUTA SAKURAI, TOKYO (JP); KAZUNORI KAMIO, TOKYO (JP)

(21) Appl. No.: 17/998,156

(22) PCT Filed: May 7, 2021
(86) PCT No.: PCT/JP2021/017540

§ 371 Date: Nov. 7, 2022

(30) Foreign Application Priority Data
May 15, 2020 (JP) 2020-086352

(51) Int. Cl. G06T 7/70; H04N 5/14; G06T 7/20; G06V 10/74

(52) U.S. Cl. CPC G06T 7/70; G06T 7/20; G06V 10/761; H04N 5/145

(57) ABSTRACT

An information processing device (1) according to the present disclosure includes a prediction unit (occlusion prediction unit 4). The prediction unit (occlusion prediction unit 4) predicts, in a case where a subject (101) in an image captured in time series by an imaging device (100) is hidden behind a foreground, a position of the subject (101) in the image behind the foreground on a basis of an image of the subject (101) in the image before being hidden behind the foreground and motion information of the imaging device (100) detected by a motion detection device (device motion information sensor 111).

### FIELD

The present disclosure relates to an information processing device, an information processing method, and an information processing program.

### BACKGROUND

In a case where images of a subject are captured in time series, occlusion may occur because the subject is hidden behind the foreground. For this reason, there is an image processing device that improves image quality by estimating a motion vector of a subject in consideration of occlusion and adding images of a plurality of frames (see, for example, Patent Document 1).

### CITATION LIST

### Patent Literature

Patent Literature 1: JP 2008-42659 A

### SUMMARY

### Technical Problem

However, in the above-described conventional technology, since the motion vector of the subject behind the foreground cannot be estimated, there is room for improvement in image quality at the time of occurrence of occlusion.

Therefore, the present disclosure proposes an information processing device, an information processing method, and an information processing program capable of improving image quality at the time of occurrence of occlusion.

### Solution to Problem

According to the present disclosure, An information processing apparatus is provided. The information processing device includes a prediction unit. The prediction unit predicts, in a case where a subject in an image captured in time series by an imaging device is hidden behind a foreground, a position of the subject in the image behind the foreground on a basis of an image of the subject in the image before being hidden behind the foreground and motion information of the imaging device detected by a motion detection device.

### BRIEF DESCRIPTION OF DRAWINGS

FIG. 1 is an explanatory diagram of a noise removal method according to the present disclosure.

FIG. 2 is a three-dimensional relationship diagram of an imaging device, an image plane, and a subject according to the present disclosure.

FIG. 3 is a schematic explanatory diagram of information processing according to the present disclosure.

FIG. 4A is an explanatory diagram of occlusion according to the present disclosure.

FIG. 4B is an explanatory diagram of occlusion according to the present disclosure.

FIG. 5 is a flowchart illustrating an example of processing executed by an information processing device according to the present disclosure.

FIG. 6 is a block diagram illustrating an overall configuration of the information processing device according to the present disclosure.

FIG. 7 is a block diagram illustrating a configuration of a search range determination unit according to the present disclosure.

FIG. 8 is a block diagram illustrating a configuration of a motion subject detection unit according to the present disclosure.

FIG. 9A is an explanatory diagram of a motion subject detection method according to the present disclosure.

FIG. 9B is an explanatory diagram of a motion subject detection method according to the present disclosure.

FIG. 10 is a block diagram illustrating a configuration of an occlusion exposure detection unit according to the present disclosure.

FIG. 11A is an explanatory diagram of a method of detecting a subject exposed from a foreground according to the present disclosure.

FIG. 11B is an explanatory diagram of a method of detecting a subject exposed from a foreground according to the present disclosure.

FIG. 12 is a block diagram illustrating a configuration of a motion vector estimation unit according to the present disclosure.

FIG. 13A is an explanatory diagram of a method of detecting a subject hidden behind a foreground according to the present disclosure.

FIG. 13B is an explanatory diagram of a method of detecting a subject hidden behind a foreground according to the present disclosure.

FIG. 14 is a block diagram illustrating a configuration of an occlusion prediction unit according to the present disclosure.

FIG. 15A is an explanatory diagram of a motion vector estimation method according to the present disclosure.

FIG. 15B is an explanatory diagram of a motion vector estimation method according to the present disclosure.

FIG. 16 is a block diagram illustrating a configuration of a high-accuracy restoration unit according to the present disclosure.

FIG. 17 is an explanatory diagram of a usage example of multi-frame addition according to the present disclosure. Description of Embodiments

Hereinafter, embodiments of the present disclosure will be described in detail with reference to the drawings. Note that, in each of the following embodiments, the same parts are denoted by the same reference numerals, and redundant description will be omitted.

### NOISE REMOVAL METHOD

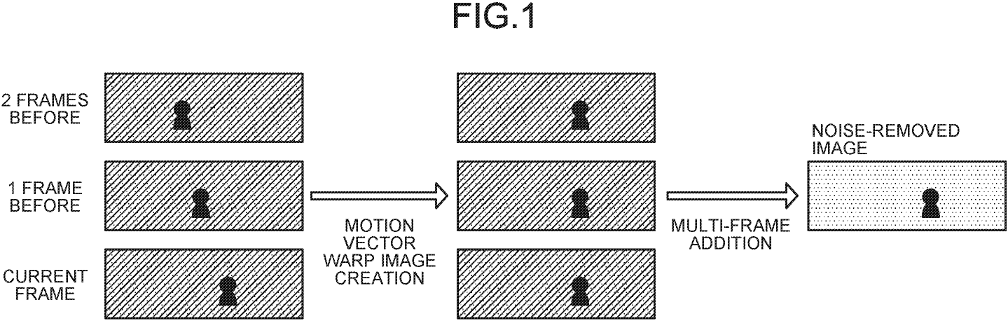

First, a noise removal method performed by the information processing device according to the present disclosure will be described with reference to FIG. 1. FIG. 1 is an explanatory diagram of a noise removal method according to the present disclosure. As illustrated in FIG. 1, for example, in a case where an image of a current frame, an image of one frame before, and an image of two frames before captured in time series are input, the information processing device calculates a motion vector of a subject from three images.

Subsequently, the information processing device creates a motion vector warp image in which the position of the subject in each image is moved to the same position on the basis of the calculated motion vector. Then, the information processing device performs multi-frame addition (combination) of the three motion vector warp images to generate a noise-removed image.

In this manner, for example, the information processing device can sharpen the image of the subject, which is unclear in each image due to the influence of noise, by performing the multi-frame addition, and thus, can generate an image with higher image quality.

The information processing device estimates the motion vector of the subject with high accuracy by using, for example, an inertial measurement unit (IMU) that captures posture and position information of the camera, a distance sensor, and the like in combination.

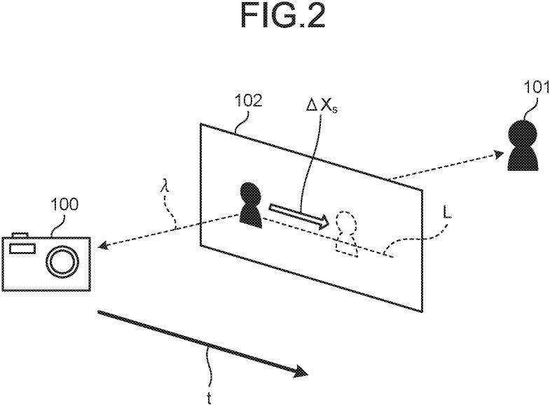

FIG. 2 is a three-dimensional relationship diagram of an imaging device, an image plane, and a subject according to the present disclosure. As illustrated in FIG. 2, in a case where the subject 101 is stationary, an in-image coordinate Xₛ of a subject 101 on an image 102 is determined by the following Formula (1) from two pieces of information of a translation vector t of an imaging device 100 and a distance λ to the subject 101.

$$\begin{matrix}{X}_{s} = \frac{1}{λ} P \left(R {X}_{w} + t\right) \\ {X}_{s} : \text{in-image} \text{coordinate} , \\ {X}_{w} : \text{three-dimensional} \text{coordinate} \text{in} \text{real} \text{world} \text{coordinate} \text{system,} \\ \text{λ:} \text{distance,} P \text{:} \text{internal} \text{parameter} \text{matrix,} R \text{:} \text{rotation} \text{matrix,} \text{and} \\ t \text{:} \text{translation} \text{vector}\end{matrix}$$

In a case where the motion information of the imaging device 100 is known by the IMU, a motion vector ΔXₛ in the image 102 of the subject 101 is calculated by the following Formula (2).

$$\begin{matrix}Δ {X}_{s} = {\left[{u}_{2} , {v}_{2}\right]}^{T} - {\left[{u}_{1} , {v}_{1}\right]}^{T} \\ {X}_{{s}_{1}} = {\left[{u}_{1} , {v}_{1}\right]}^{Τ} : \text{coordinate} \text{on} \text{image} \text{before} \text{movement,} \text{and} \\ {\text{X}}_{{s}_{2}} = {\left[{u}_{2} , {v}_{2}\right]}^{T} : \text{coordinate} \text{on} \text{image} \text{after} \text{movement}\end{matrix}$$

Then, in a case where the subject 101 is stationary, the motion vector ΔXₛ in the image 102 of the subject 101 can be limited to a straight line called an epipolar line L illustrated in FIG. 2 calculated by the following Formula (3).

$${v}_{2} = \frac{{A}_{2} \left({u}_{1} , {v}_{1}\right)}{{A}_{1} \left({u}_{1} , {v}_{2}\right)} \left({u}_{2} - {C}_{1}\right) + {C}_{2}$$

For this reason, the information processing device can greatly improve the noise removal performance by using the IMU and the distance sensor in combination when performing the noise removal of the image.

### OVERVIEW OF INFORMATION PROCESSING

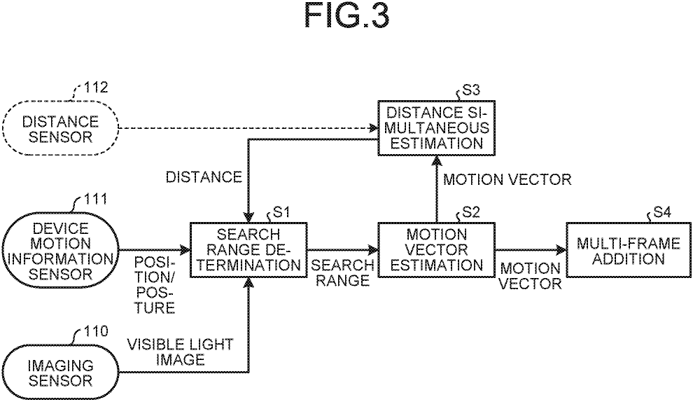

FIG. 3 is a schematic explanatory diagram of information processing according to the present disclosure. For example, the information processing device acquires motion information including the position and posture of the imaging device 100 from a device motion information sensor 111 such as an IMU, and acquires a visible light image from an imaging sensor 110 of the imaging device 100. The device motion information sensor 111 is an example of a motion detection device that detects motion information of the imaging device 100.

Subsequently, the information processing device determines a search range of a motion vector of a subject in the visible light image on the basis of the acquired motion information (step S1). Thereafter, the information processing device estimates the motion vector of the subject within the determined search range (step S2). The information processing device uses the estimated motion vector of the subject for image quality enhancement by multi-frame addition illustrated in FIG. 1.

Here, if the motion vector of the subject can be estimated, the information processing device can estimate the distance λ at the same time as the motion vector since the unknown in the above Formula (1) is only the distance λ to the subject (step S3). The information processing device can perform motion vector estimation of the subject with higher accuracy by reflecting the estimated distance λ in the search range determination processing in the next frame.

Note that, in a case where a distance sensor 112 that measures the distance λ from the imaging sensor 110 to the subject is connected, the information processing device can acquire the distance λ from the distance sensor 112 and reflect the distance λ in the search range determination processing in the next frame.

The information processing device estimates the motion vector of a subject for each of the visible light images sequentially input from the imaging sensor 110, creates the motion vector warp image illustrated in FIG. 1 on the basis of the motion vector, and performs multi-frame addition (step S4).

### MODIFICATION OF MOTION DETECTION DEVICE

Note that, here, a case where the motion detection device is an IMU will be described, but the motion detection device may be another sensor such as a global positioning system (GPS) sensor, for example, as long as the sensor can detect motion information of the imaging device 100. In addition, the imaging device 100 is not limited to the visible light camera, and may be, for example, another camera such as an infrared light camera.

The information processing device can substitute another sensor for the IMU, and can acquire the motion information of the imaging sensor 110 by using the IMU and another sensor in combination. Specifically, in a case where imaging by the imaging sensor 110 takes a long time, the information processing device uses another sensor in combination in order to correct a measurement error of the IMU.

For example, in a situation where the movement amount of the imaging sensor 110 is sufficiently large such as a case where the imaging sensor 110 is an in-vehicle camera, the information processing device can acquire highly accurate motion information of the imaging sensor 110 by using the IMU and the GPS in combination.

Furthermore, in addition to the above configuration, the information processing device may include the distance sensor 112 (see FIG. 3) that acquires the distance λ to the subject in the processing system. Examples of the distance sensor 112 include a time-of-flight (ToF) distance measurement sensor, LiDAR, LADAR, a stereo camera, and the like. Since the information processing device can estimate the motion vector of the subject more accurately by using the distance sensor 112 in combination, it is possible to generate an image with higher image quality.

In addition, the information processing device can perform real-time processing on images sequentially acquired in time series from the imaging sensor 110, but can also perform processing on a computer connected via a network, for example. In addition, the information processing device can store information obtained from each sensor in a recording medium and perform the information on a computer as post-processing.

### PROBLEM

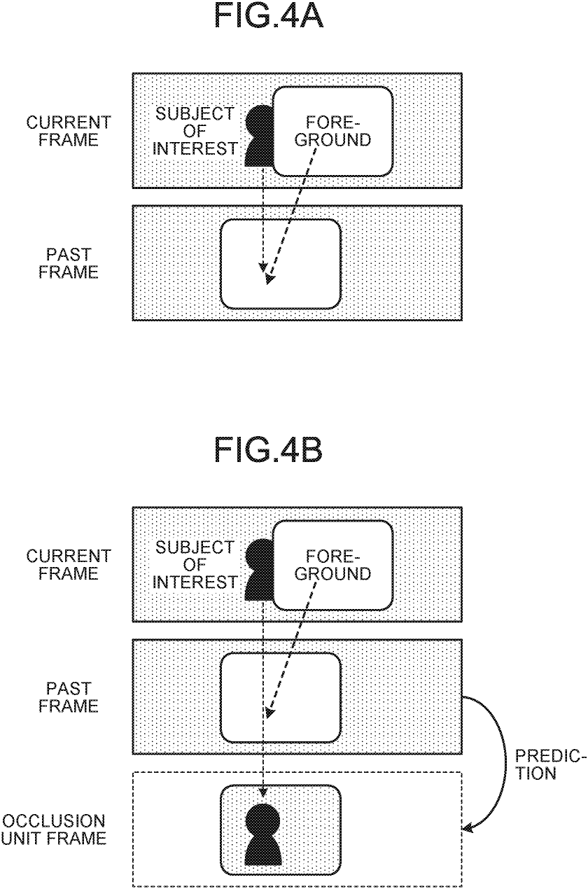

Here, in a case where the information processing device performs the processing illustrated in FIG. 3, occlusion in which the subject 101 is hidden behind the foreground may occur due to movement of the imaging sensor 110 or movement of the subject 101. FIGS. 4A and 4B are explanatory diagrams of occlusion according to the present disclosure.

As illustrated in FIG. 4A, in a case where the subject of interest appears from behind the foreground, since the subject of interest in the current frame is shielded by the foreground up to one frame before, the motion vector is not correctly estimated. As a result, when the information processing device performs the multi-frame addition, significant image quality degradation such as a double image occurs around the occlusion unit.

### OPERATION OF INFORMATION PROCESSING DEVICE

Therefore, as illustrated in FIG. 4B, the information processing device performs prediction processing of pixel information of the subject of interest in the occlusion unit frame. In a case where the information processing device detects that the subject of interest has been shielded by the foreground, the information processing device holds the image information immediately before that.

The information processing device holds the pixel information of the subject of interest in the occlusion unit frame on the frame memory over a plurality of frames, and moves the pixel position of the subject of interest on the same frame memory each time the frame advances.

If the information processing device can acquire the motion information of the imaging sensor 110 and acquire or estimate the distance λ to the subject 101, the information processing device can determine the movement destination in the image of the subject 101, that is, the end point of the motion vector (see Formula (2)) as one point by the above Formula (1).

As a result, the information processing device can predict the pixel position of the subject 101 in the next frame. In addition, as illustrated in FIG. 4B, in a case where the subject of interest is exposed from the occlusion unit frame, the information processing device matches the exposed pixel position of the subject of interest in the current frame with the estimated pixel position of the subject of interest in the occlusion unit frame held in the frame memory, and performs multi-frame addition.

In order to estimate the pixel position of the subject of interest in the occlusion unit frame with high accuracy, the information processing device detects the motion subject in advance before estimating the pixel position of the subject of interest in the occlusion unit frame.

For example, the information processing device compares the motion vector of the subject 101 estimated using the compressed image with the reduced resolution with the search range of the motion vector of the subject 101 estimated using the motion information of the imaging sensor 110 acquired from the IMU. Then, in a case where the estimated motion vector greatly deviates from the search range, the information processing device determines that the motion subject is present.

As described above, by detecting the motion subject, the information processing device can separately estimate the pixel position of the subject of interest in the occlusion unit frame caused by each of the motion subject and the motion of the imaging sensor 110.

### PROCESSING FLOW OF INFORMATION PROCESSING DEVICE

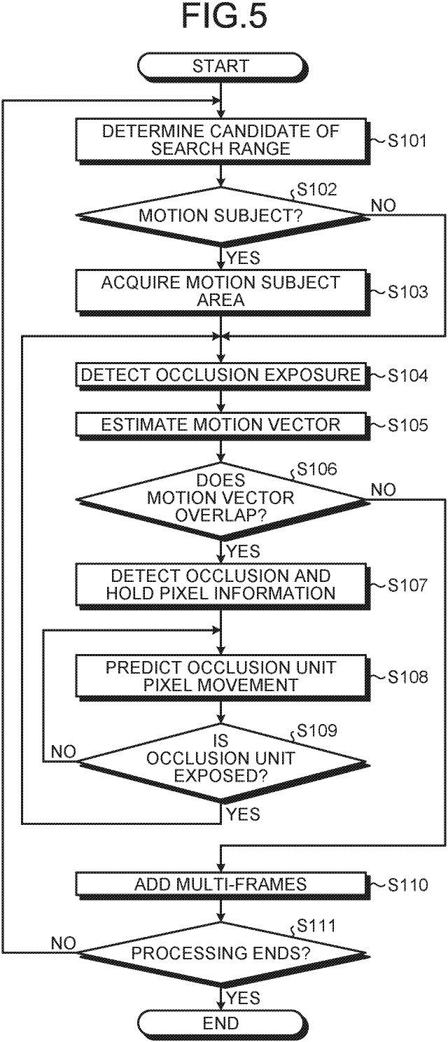

FIG. 5 is a flowchart illustrating an example of processing executed by an information processing device according to the present disclosure. As illustrated in FIG. 5, the information processing device determines a candidate of a search range of a motion vector of the subject 101 from the motion information of the imaging sensor 110 acquired from the device motion information sensor 111 and the image acquired from the imaging sensor 110 (step S101).

Subsequently, the information processing device determines whether or not the subject 101 is a motion subject by comparing the search ranges (step S102). Then, in a case where it is determined that the subject is a motion subject (step S102, Yes), the information processing device acquires a motion subject area in the image (step S103), and moves the processing to step S104.

In addition, in a case where it is determined that the subject is not a motion subject (step S102, No), the information processing device moves the processing to step S104. In step S104, the information processing device performs occlusion exposure detection. Specifically, the information processing device detects the pixel of the subject 101 exposed from an occlusion unit that is an area in which the subject is hidden by the foreground in the image, and determines a final search range.

Subsequently, the information processing device estimates the motion vector of the subject 101 on the basis of the search range (step S105). Thereafter, the information processing device determines whether or not the estimated end point of the motion vector overlaps the foreground in the image (step S106). That is, the information processing device determines whether or not the subject 101 in the image is hidden by the foreground.

Then, in a case where it is determined that the end point of the motion vector overlaps the foreground (step S106, Yes), the information processing device detects occlusion and holds pixel information of the occlusion unit (step S107).

Subsequently, the information processing device performs occlusion unit pixel movement prediction (step S108). Specifically, the information processing device predicts the pixel position of the subject 101 in the next frame from the motion information of the imaging sensor 110 acquired from the device motion information sensor 111 and the distance λ to the subject 101. That is, the information processing device predicts the movement position of the subject 101 hidden behind the foreground in the next frame image.

Thereafter, the information processing device determines whether or not the subject 101 is exposed from the occlusion unit (foreground) (step S109). Then, in a case where it is determined that the subject 101 is exposed (step S109, Yes), the information processing device moves the processing to step S104.

In a case where it is determined that the subject 101 is not exposed (step S109, No), the information processing device moves the processing to step S108. The pixel of the subject determined to be exposed is used for estimating the motion vector of the subject in the next frame.

In addition, in step S106, in a case where it is determined that the end point of the motion vector does not overlap the foreground (step S106, No), the information processing device performs multi-frame addition (step S110), and determines whether or not the processing has ended (step S111). The coefficient used for addition by the information processing device is controlled by reliability determined on the basis of an update history in the occlusion unit and the like. Details of the reliability will be described later.

Then, in a case where it is determined that the processing has not ended (Step S111, No), the information processing device moves the processing to step S101. In addition, in a case where it is determined that the processing has ended (step S111, Yes), the information processing device ends the processing.

### CONFIGURATION OF INFORMATION PROCESSING DEVICE

### 7.1. Configuration of Information Processing Device

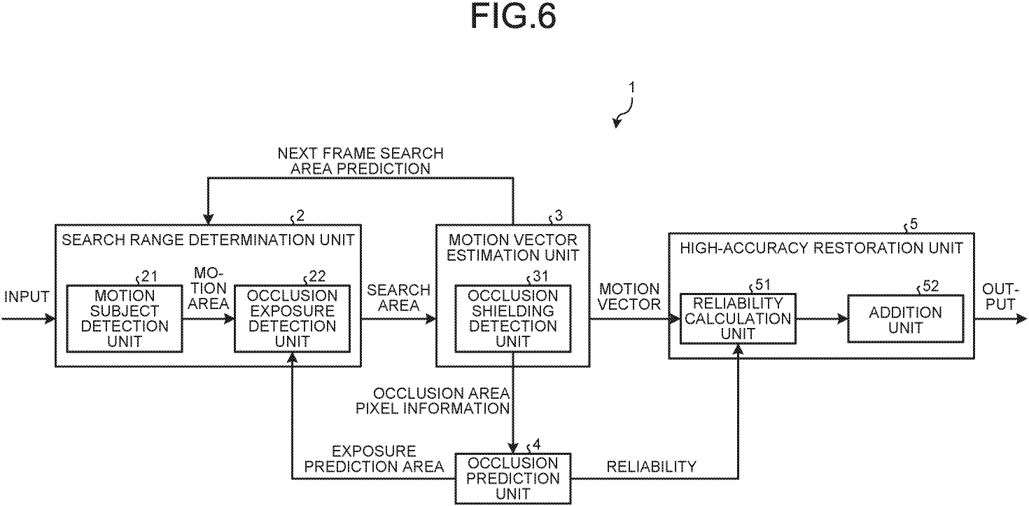

FIG. 6 is a block diagram illustrating an overall configuration of the information processing device according to the present disclosure. An information processing device 1 includes a microcomputer including a central processing unit (CPU), a read only memory (ROM), a random access memory (RAM), and the like, and various circuits.

As illustrated in FIG. 6, the information processing device 1 includes a search range determination unit 2, a motion vector estimation unit 3, an occlusion prediction unit 4, and a high-accuracy restoration unit 5 that function when the CPU executes a program stored in the ROM by using the RAM as a work area.

Note that some or all of the search range determination unit 2, the motion vector estimation unit 3, the occlusion prediction unit 4, and the high-accuracy restoration unit 5 included in the information processing device 1 may include hardware such as an application specific integrated circuit (ASIC) or a field programmable gate array (FPGA).

Each of the search range determination unit 2, the motion vector estimation unit 3, the occlusion prediction unit 4, and the high-accuracy restoration unit 5 included in the information processing device 1 realizes or executes an action of information processing described below. Note that the internal configuration of the information processing device 1 is not limited to the configuration illustrated in FIG. 6, and may be another configuration as long as information processing to be described later is performed.

The search range determination unit 2 includes a motion subject detection unit 21, an occlusion exposure detection unit 22, and the like. The motion vector estimation unit 3 includes an occlusion shielding detection unit 31 and the like. The high-accuracy restoration unit 5 includes a reliability calculation unit 51, an addition unit 52, and the like.

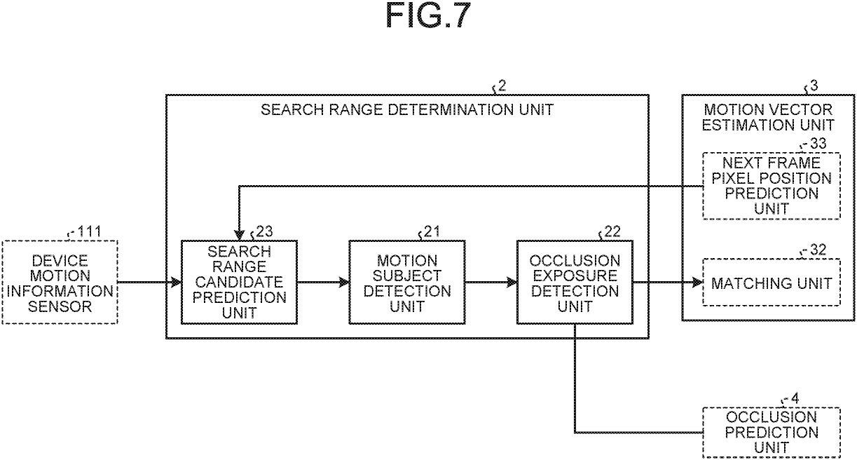

The motion information of the imaging sensor 110 detected by the device motion information sensor 111 and the images captured in time series by the imaging sensor 110 are sequentially input to the search range determination unit 2. The search range determination unit 2 determines a search range of the subject 101 in the image, and outputs an area (search area) of the determined search range to the motion vector estimation unit 3. Details of the search range determination unit 2 will be described later with reference to FIG. 7.

The motion vector estimation unit 3 estimates the motion vector of the subject 101 in the search area in the image and outputs the motion vector to the high-accuracy restoration unit 5. In addition, in a case where the subject 101 is hidden behind the foreground, the motion vector estimation unit 3 outputs occlusion area pixel information in the image to the occlusion prediction unit 4.

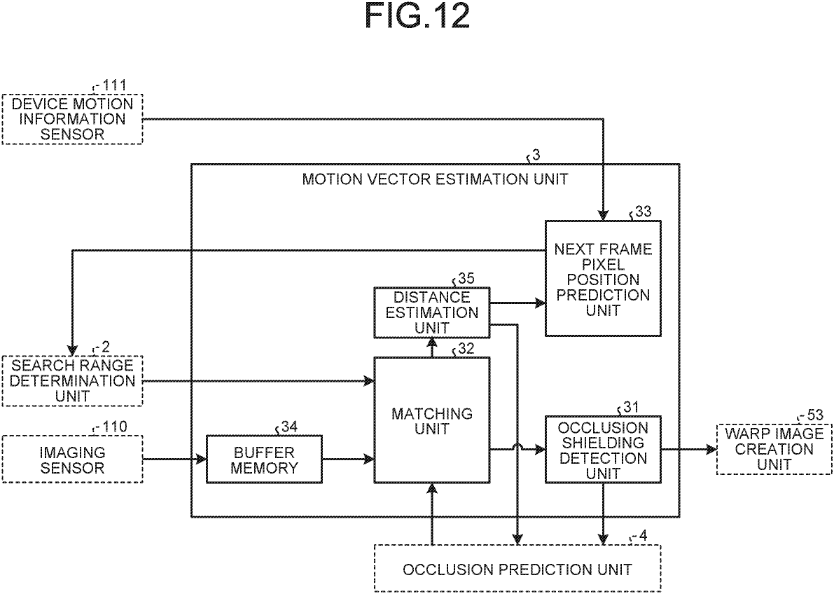

In addition, the motion vector estimation unit 3 also predicts a next frame search area on the basis of the estimated motion vector of the subject 101, and outputs the predicted search area to the search range determination unit 2. Details of the motion vector estimation unit 3 will be described later with reference to FIG. 12.

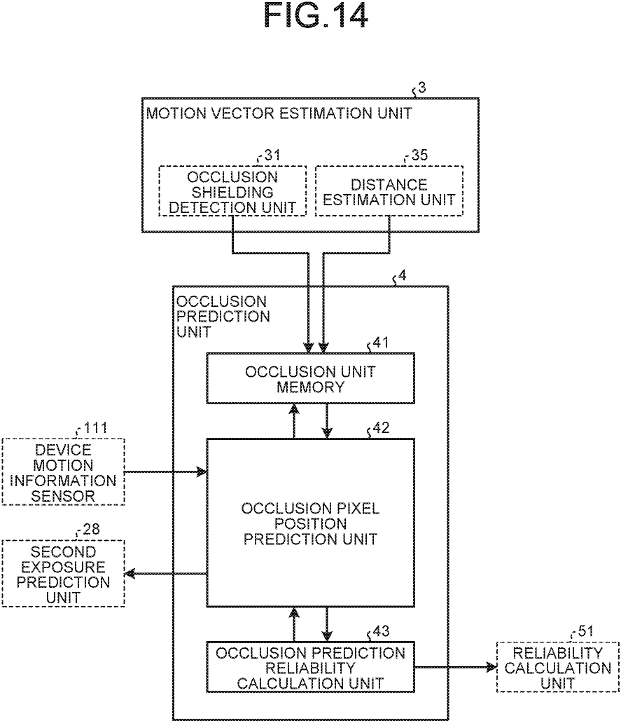

The occlusion prediction unit 4 predicts an exposure prediction area in which the subject 101 is exposed (appears) from behind the foreground on the basis of the occlusion area pixel information, and outputs the exposure prediction area to the search range determination unit 2. In addition, the occlusion prediction unit 4 calculates the reliability of the pixel of the subject 101 in the image on the basis of the occlusion area pixel information, and outputs the reliability to the high-accuracy restoration unit 5. Details of the occlusion prediction unit 4 will be described later with reference to FIG. 14.

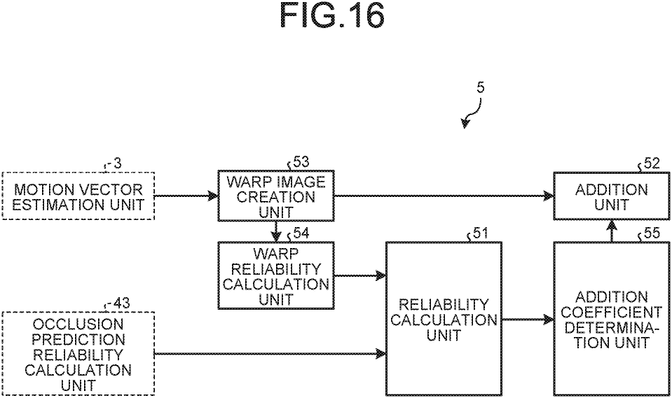

The high-accuracy restoration unit 5 creates a motion vector warp image (see FIG. 1) from time-series images on the basis of the motion vector of the subject 101 input from the motion vector estimation unit 3, and outputs an image restored by multi-frame addition. At this time, the high-accuracy restoration unit 5 and performs multi-frame addition at a ratio according to the reliability input from the occlusion prediction unit 4. Details of the high-accuracy restoration unit 5 will be described later with reference to FIG. 16.

### 7.2. Configuration of Search Range Determination Unit

FIG. 7 is a block diagram illustrating a configuration of a search range determination unit according to the present disclosure. As illustrated in FIG. 7, the search range determination unit 2 includes a search range candidate prediction unit 23, the motion subject detection unit 21, and the occlusion exposure detection unit 22.

The search range candidate prediction unit 23 derives a search range candidate of a motion vector of the subject 101 in the image on the basis of the motion information of the imaging sensor 110 input from the device motion information sensor 111. In addition, although not illustrated here, the search range candidate prediction unit 23 derives a search range candidate of the motion vector of the subject 101 on the basis of a reduced image (compressed image) of an image input from the imaging sensor 110.

At this time, the search range candidate prediction unit 23 predicts a search range candidate using the next frame pixel position predicted by a next frame pixel position prediction unit 33 in the motion vector estimation unit 3. The next frame pixel position is the position of the pixel of the subject 101 in the current frame predicted from the image one frame before. The search range candidate prediction unit 23 outputs the search range candidates derived by each of the above two methods to the motion subject detection unit 21.

Specifically, the search range candidate prediction unit 23 determines an epipolar line (Mathematical formula 3) that is a motion vector search range on the basis of the motion information of the imaging sensor 110 acquired from the device motion information sensor 111. In a case where the distance λ to the subject 101 has been estimated, the information on the end point of the motion vector can be acquired from the next frame pixel position prediction unit 33 by the above Formula (1) and used.

The motion subject detection unit 21 compares the search range candidates derived by the two methods, detects an area of the moving subject in the image, and outputs the detected area of the moving subject to the occlusion exposure detection unit 22.

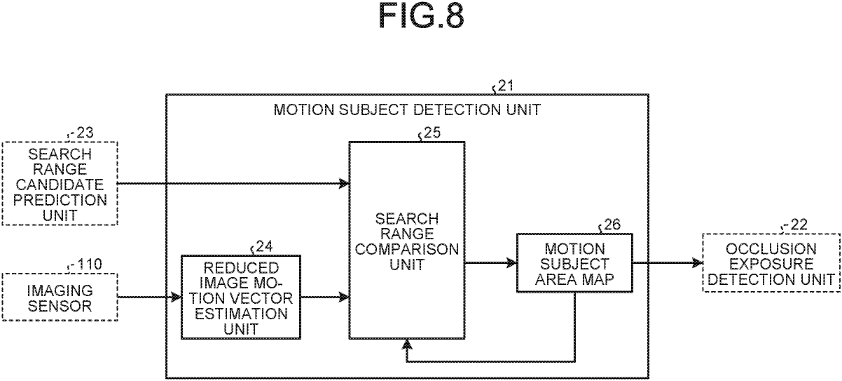

When the subject 101 has motion, the movement of the subject 101 in the image is not limited on the epipolar line (Mathematical formula 3). Therefore, the motion subject detection unit 21 efficiently and accurately detects the motion subject by obtaining the motion vector of the subject 101 from the compressed image with reduced resolution and comparing the motion vector with the epipolar line. Details of the motion subject detection unit 21 will be described later with reference to FIG. 8.

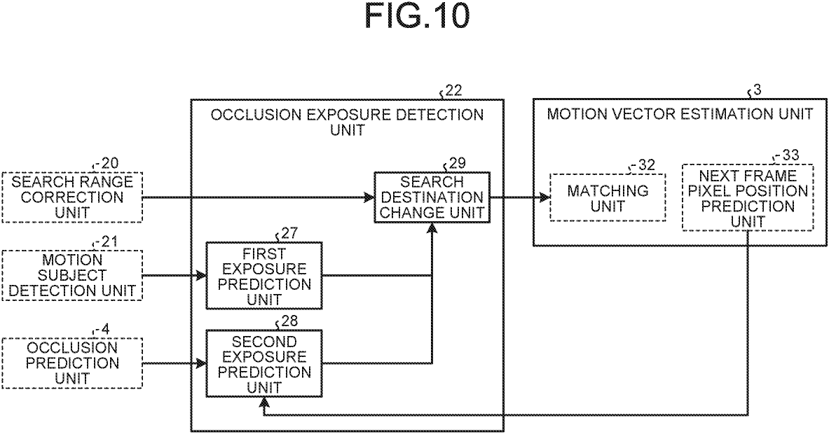

The occlusion exposure detection unit 22 predicts a position in the image where the subject shielded by the foreground is exposed from behind the foreground, and outputs a prediction result to a matching unit 32 in the motion vector estimation unit 3. At this time, the occlusion exposure detection unit 22 predicts a position in the image of the subject 101 exposed from behind the foreground using the exposure prediction area input from the occlusion prediction unit 4. Details of the occlusion exposure detection unit 22 will be described later with reference to FIG. 10.

### 7.3. Configuration of Motion Subject Detection Unit

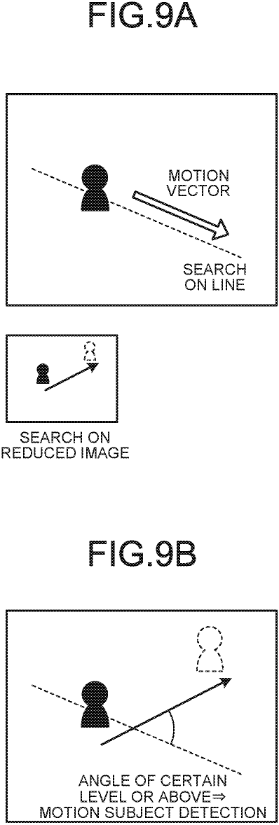

FIG. 8 is a block diagram illustrating a configuration of a motion subject detection unit according to the present disclosure. FIGS. 9A and 9B are explanatory diagrams of a motion subject detection method according to the present disclosure. As illustrated in FIG. 8, the motion subject detection unit 21 includes a reduced image motion vector estimation unit 24 and a search range comparison unit 25.

The reduced image motion vector estimation unit 24 reduces and compresses the resolutions of the current frame and the past frame acquired from the imaging sensor 110, estimates a motion vector by block matching, and outputs the motion vector to the search range comparison unit 25.

As illustrated in FIG. 9A, the search range comparison unit 25 compares the motion vector indicated by the solid arrow estimated from the reduced image (compressed image) with the search range candidate indicated by the dotted line input from the search range candidate prediction unit 23. Then, as illustrated in FIG. 9B, in a case where a pixel area in which the estimated motion vector greatly deviates from the search range candidate is detected, the search range comparison unit 25 regards the area as the moving subject 101 and records the area in a motion subject area map 26.

Specifically, the search range comparison unit 25 determines that the subject 101 is a moving subject 101 in a case where an angle formed by the motion vector of the subject 101 along an epipolar line indicated by a dotted line in FIG. 9B estimated from motion information of the imaging sensor 110 and the motion vector indicated by a solid arrow of the subject 101 estimated from a reduced image (compressed image) exceeds a threshold value on the basis of the following Formula (4).

$$\begin{matrix}M o t i o n = \left\{\begin{matrix}1 & \left(i f Δ θ > t h r e s h o l d , \left|Δ {X}_{s}\right| > t h r e s h o l d\right) \\ 0 & \left(e l s e\right)\end{matrix}\right) \\ Δ θ : \text{angle} \text{formed} \text{by} \text{epipolar} \text{line} \left(\text{Mathematical} \text{formula} 3\right) \text{and} \\ \text{motion} \text{vector} Δ {X}_{s} , \text{and} \\ \left|Δ {X}_{s}\right| : \text{norm} \text{of} \text{motion} \text{vector} Δ {X}_{s}\end{matrix}$$

The search range comparison unit 25 outputs the recorded information of the motion subject area map 26 to the occlusion exposure detection unit 22 in the subsequent stage. Note that the search range comparison unit 25 may feed back the information of the motion subject area map 26 to the search range comparison unit 25 and use the information for subsequent motion subject detection. For the pixel in which the subject motion is recognized, the search range is determined on the basis of the motion vector indicated by the solid arrow obtained in the reduced image (compressed image).

### 7.4. Configuration of Occlusion Exposure Detection Unit

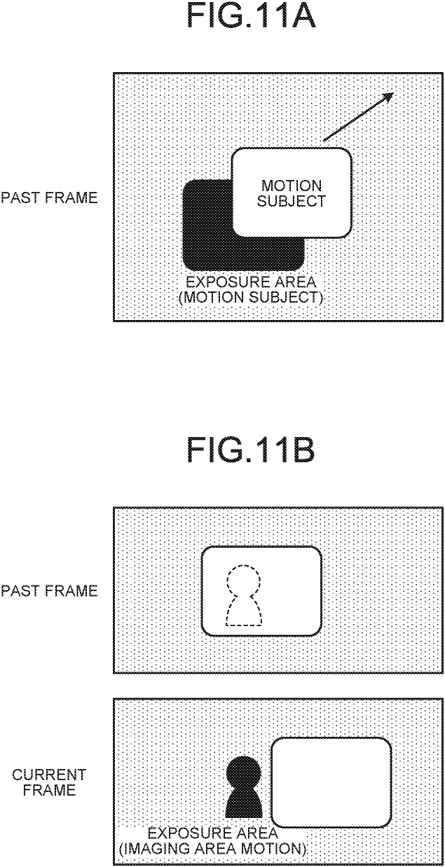

FIG. 10 is a block diagram illustrating a configuration of an occlusion exposure detection unit according to the present disclosure. FIGS. 11A and 11B are explanatory diagrams of a method of detecting a subject exposed from a foreground according to the present disclosure. As illustrated in FIG. 11, the occlusion exposure detection unit 22 includes a first exposure prediction unit 27, a second exposure prediction unit 28, and a search destination change unit 29.

As illustrated in FIGS. 11A and 11B, occlusion occurs due to movement of the subject 101 and movement of the imaging sensor 110. For this reason, the occlusion exposure detection unit 22 independently performs exposure prediction for each of the movement of the subject 101 and the movement of the imaging sensor 110.

The first exposure prediction unit 27 predicts occlusion caused by a motion subject. As illustrated in FIGS. 10 and 11A, the first exposure prediction unit 27 acquires the motion subject area map 26 (see FIG. 8) from the motion subject detection unit 21, and predicts the exposure portion on the basis of the movement amount of the subject in the image. At this time, the first exposure prediction unit 27 predicts the exposure portion by the following Formula (5).

$$\begin{matrix}E x p o s u r e 1 = \left\{\begin{matrix}1 & \left(i f {X}_{s} ∉ M o t i o n \left(i\right) a n d {X}_{s} ∈ M o t i o n \left(i - 1\right)\right) \\ 0 & \left(e l s e\right)\end{matrix}\right) \\ M o t i o n \left(i\right) : \text{motion} \text{subject} \text{in} \text{ith} \text{frame}\end{matrix}$$

On the other hand, the second exposure prediction unit 28 predicts occlusion due to the motion of the imaging sensor 110. As illustrated in FIG. 11B, the second exposure prediction unit 28 acquires distance information from the occlusion prediction unit 4 and the next frame pixel position prediction unit 33, respectively, and detects exposure of the subject 101 from the occlusion unit in a case where the foreground subject is not recognized. At this time, the second exposure prediction unit 28 predicts the exposure portion by the following Formula (6).

$$\begin{matrix}E x p o s u r e 2 = \left\{\begin{matrix}1 & \left(i f ∀ {X}_{s} ∈ T a p , {d}_{o c c} \left({X}_{s}\right) < {d}_{i} \left({X}_{s}\right)\right) \\ 0 & \left(e l s e\right)\end{matrix}\right) \\ T a p : \text{tap} \text{filter,} \\ {\text{d}}_{i} \left({X}_{s}\right) : \text{distance} \text{at} \text{pixel} \text{position} {X}_{s} \text{in} \text{ith} \text{frame,} \text{and} \\ {\text{d}}_{o c c} \left({X}_{s}\right) : \text{distance} \text{at} \text{pixel} \text{position} {X}_{s} \text{in} \text{occlusion} \text{frame}\end{matrix}$$

The first exposure prediction unit 27 and the second exposure prediction unit 28 output information indicating the position of the predicted exposure portion in the image to the search destination change unit 29.

The search destination change unit 29 integrates the information on the exposure portions input from the first exposure prediction unit 27 and the second exposure prediction unit 28. If the pixel of interest is not an exposure portion, the search destination change unit 29 sets the search destination of the motion vector to the past frame, and adopts the pixel position corrected by a search range correction unit 20 described in the modification described later or the search range obtained by the motion subject detection unit 21. In a case where the pixel of interest is an exposure portion, an occlusion unit memory sequentially updated by the occlusion prediction unit 4 is set as a search destination.

### 7.5. Modification of Search Range Determination unit

The search range determination unit 2 may include, immediately after the search range candidate prediction unit 23, the search range correction unit 20 that considers an error in motion information measured by the device motion information sensor 111 such as an IMU or predicted position information. A plurality of methods is presumed for setting the error range, but in one embodiment, the search range is expanded assuming an error distribution around the search range candidate obtained in the previous stage. For setting the standard deviation of the error distribution, a value given in advance may be used, or the value may be adjusted for each elapsed time of photographing.

As a modification of the search range correction unit 20, processing of comparing the search range candidate predicted by the search range candidate prediction unit 23 with the motion vector estimated by the motion vector estimation unit 3 and reflecting the comparison result in the setting of the error range in the next frame is presumed.

For example, processing can be considered in which an average value of an end point error (EPE) calculated by the following Formula (7) is regarded as a standard deviation σ of the error distribution, and a concentric circle having a radius 2σ or 3σ is regarded as the search range. With this processing, it is possible to estimate the actual influence of the error in the motion information measured by the device motion information sensor 111 such as the IMU and the predicted position information.

$$\begin{matrix}E P E = {\left(Δ {X}_{s}\right)}_{m a t c h} - {\left(Δ {X}_{s}\right)}_{e s t} \\ {\left(Δ {X}_{s}\right)}_{m a t c h} : \text{motion} \text{vector} \text{estimated} \text{by} \text{matching,} \text{and} \\ {\left(Δ {X}_{s}\right)}_{e s t} : \text{motion} \text{vector} \text{estimated} \text{by} \text{pixel} \text{position} \text{prediction}\end{matrix}$$

### 7.6. Motion Vector Estimation Unit

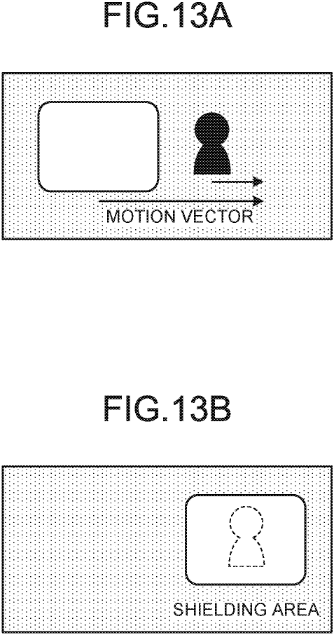

FIG. 12 is a block diagram illustrating a configuration of a motion vector estimation unit according to the present disclosure. FIGS. 13A and 13B are explanatory diagrams of a method of detecting a subject hidden behind a foreground according to the present disclosure.

As illustrated in FIG. 12, the motion vector estimation unit 3 includes a buffer memory 34, the matching unit 32, the occlusion shielding detection unit 31, a distance estimation unit 35, and the next frame pixel position prediction unit 33.

The motion vector estimation unit 3 estimates the motion vector of the subject 101 on the basis of the search destination / search range determined by the search range determination unit 2. The matching unit 32 estimates a motion vector for the current frame from the past frame held in the buffer memory 34, acquires pixel information of the occlusion unit memory from the occlusion prediction unit 4, and performs matching with the current frame.

In a case where the subject 101 of the pixel of interest is stationary, the distance estimation unit 35 estimates the distance λ from the imaging sensor 110 to the subject 101 on the basis of the motion vector and the epipolar line (see Formula (3)).

The next frame pixel position prediction unit 33 substitutes the distance λ input from the distance estimation unit 35 and the motion information input from the device motion information sensor 111 such as the IMU into Formula (1) to predict the pixel position of the subject 101 in the next frame. The next frame pixel position prediction unit 33 can greatly limit the search range in the next frame by the search range determination unit 2 by outputting the predicted pixel position to the search range determination unit 2.

The occlusion shielding detection unit 31 detects an area where the subject 101 is shielded by the foreground, using the motion vector estimated by the matching unit 32. The occlusion shielding detection unit 31 determines an area in which the end point of the motion vector input from the matching unit 32 overlaps the foreground as occlusion (shielding area) on the basis of the following Formula (8) (see FIGS. 13A and 13B).

$$\begin{matrix}O c c l u s i o n = \left\{\begin{matrix}1 & \left(i f ∀ {X}_{s} ∈ T a p , N \left(Δ {X}_{s}\right) > 1\right) \\ 0 & \left(e l s e\right)\end{matrix}\right) \\ T a p : \text{tap} \text{filter,} \text{and} \\ N \left(Δ {X}_{s}\right) : \text{number} \text{of} \text{motion} \text{vectors} \text{with} \text{pixel} \text{position} {\text{X}}_{\text{s}} \text{as} \text{end} \text{point}\end{matrix}$$

The occlusion shielding detection unit 31 outputs pixel information in the area determined to be occlusion to the occlusion prediction unit 4 and a warp image creation unit 53 in the high-accuracy restoration unit 5.

### 7.7. Modification of Motion Vector Estimation Unit

The motion vector estimation unit 3 can estimate a motion vector by block matching or a gradient method, but can also estimate a motion vector by inference based on learning data.

The motion vector estimation unit 3 may incorporate filtering processing before the matching unit 32 in a case where image quality degradation of the input image is significant. There are many techniques for filtering, but for example, a bilateral filter can be used.

In addition, the distance estimation unit 35 may use the distance sensor 112 in combination for distance estimation. A plurality of embodiments is presumed for integration of the obtained distance information. For example, the distance estimation unit 35 can adjust the weighting of the estimated distance by the motion vector and the measurement distance obtained from the distance sensor 112 according to the brightness of the environment.

In addition, the distance estimation unit 35 can also adjust the weighting by the size of the motion vector in consideration of the accuracy of the estimated distance by the motion vector. Furthermore, the distance estimation unit 35 can determine an appropriate coefficient in consideration of a plurality of performance degradation factors by preliminary learning using a data set.

### 7.8. Occlusion Prediction Unit

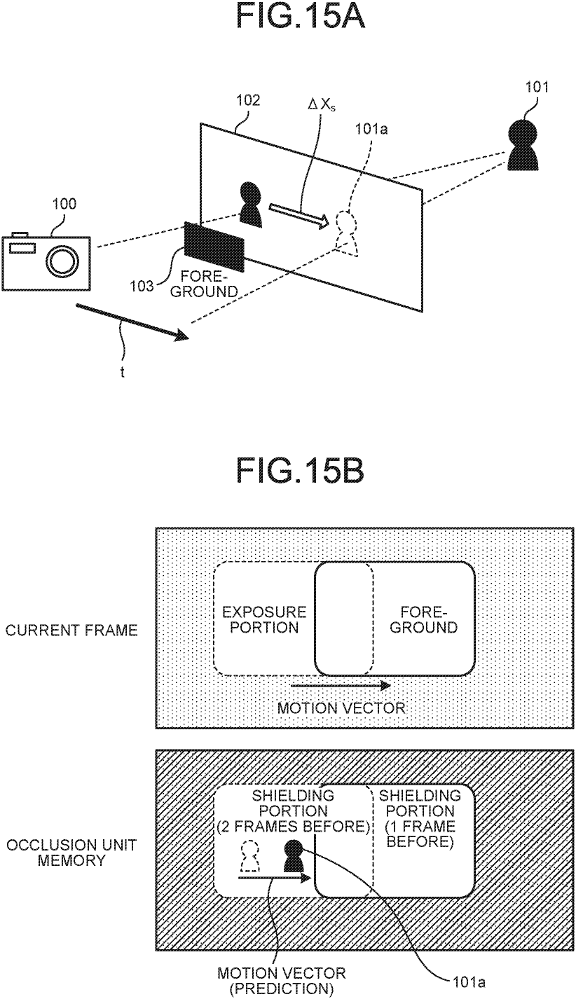

FIG. 14 is a block diagram illustrating a configuration of an occlusion prediction unit according to the present disclosure. FIGS. 15A and 15B are explanatory diagrams of a motion vector estimation method according to the present disclosure.

As illustrated in FIG. 14, the occlusion prediction unit 4 includes an occlusion unit memory 41, an occlusion pixel position prediction unit 42, and an occlusion prediction reliability calculation unit 43. The occlusion unit memory 41 acquires and stores the luminance value and the distance information of the subject 101 of interest shielded by the foreground input from the motion vector estimation unit 3.

The occlusion pixel position prediction unit 42 can predict the movement of the subject 101 over several frames even if there is the subject 101 shielded by the foreground, by using the motion information of the imaging sensor 110 input from the device motion information sensor 111 such as the IMU and the distance information to the subject 101 estimated before shielding. The occlusion pixel position prediction unit 42 uses the motion information and the distance information of the imaging sensor 110 to predict the pixel position of the subject 101 in the next frame on the basis of Formula (1).

Then, as illustrated in FIGS. 15A and 15B, the occlusion pixel position prediction unit 42 moves the luminance value and the distance information of the pixel with respect to the predicted pixel position of a subject 101a. In the occlusion prediction unit 4, sequentially updated information is overwritten in the occlusion unit memory 41, but the pixel information updated at this time and the pixel information newly input from the motion vector estimation unit 3 are written in the same memory.

In a case where the pixel positions overlap at the time of update, the occlusion pixel position prediction unit 42 leaves only pixel information with a short distance. The occlusion pixel position prediction unit 42 outputs distance information to the second exposure prediction unit 28 of the occlusion exposure detection unit 22 each time of update, and in a case where exposure is predicted, outputs a luminance value of the pixel to the matching unit 32 of the motion vector estimation unit 3.

The occlusion prediction reliability calculation unit 43 calculates the reliability according to the number of times of update of the pixel position and the movement distance, for example, using the following Formula (9).

$$\begin{matrix}C o n {f}_{o c c} \left(i , {X}_{s}\right) = f \left(t\right) ⋅ C o n {f}_{o c c} \left(i - 1 , {X}_{s} - Δ {X}_{s}\right) \\ C o n {f}_{o c c} \left(i , {X}_{s}\right) ∈ \left[0 , 1\right] : \text{occlusion} \text{prediction} \text{reliability,} \text{and} \\ \text{f} \left(t\right) : \text{function} \text{corresponding} \text{to} \text{translation} \text{vector} t \left(\text{set} \text{arbitrarily}\right)\end{matrix}$$

The occlusion pixel position prediction unit 42 transmits the calculated reliability to the reliability calculation unit 51 in the high-accuracy restoration unit 5 in the subsequent stage. In a case where the reliability falls below a certain threshold value, the occlusion pixel position prediction unit 42 deletes the pixel information from the occlusion unit memory 41.

In addition, even in a case where the subject 101 goes out of the frame, the occlusion pixel position prediction unit 42 deletes the pixel information from the occlusion unit memory 41. As a result, in the occlusion unit memory 41, only pixel information minimum required for interpolation of the occlusion unit is held.

### 7.9. Modification of Occlusion Prediction Unit

In a case where a motion subject is present in the image, the occlusion prediction unit 4 can also acquire the motion vector of the area from the motion vector estimation unit 3, and estimate the pixel position of the subject 101 in the next frame on the basis of the motion vector. At the time of estimation in this case, it is necessary to assume that the shielded motion subject continues the same motion over several frames.

In a case where the distance λ is accurately obtained, the occlusion prediction unit 4 can obtain the direction and speed of the motion of the motion subject in the real world. In a case where there is uncertainty in the distance, the occlusion prediction unit 4 may perform processing on the assumption that the motion of the motion subject in the real world is not obtained and the same motion vector is kept on the image.

In addition, the occlusion prediction unit 4 may sequentially change the value of the reliability according to the estimation result by the motion vector estimation unit 3. In a case where block matching is performed by the motion vector estimation unit 3, the occlusion prediction unit 4 can acquire an error amount in the template. In addition, the occlusion prediction unit 4 controls the value of the reliability according to the error amount of matching in the occlusion exposure detection unit 22, in a manner that appropriate addition processing according to the photographing environment is realized in the high-accuracy restoration unit 5 in the subsequent stage. Note that the occlusion prediction reliability calculation unit 43 can also determine the value of the reliability by learning in advance.

### 7.10. High-accuracy Restoration Unit

FIG. 16 is a block diagram illustrating a configuration of a high-accuracy restoration unit according to the present disclosure. As illustrated in FIG. 16, the high-accuracy restoration unit 5 includes the warp image creation unit 53, a warp reliability calculation unit 54, the reliability calculation unit 51, an addition coefficient determination unit 55, and the addition unit 52.

The warp image creation unit 53 warps the addition image of the past frame to the pixel position of the current frame on the basis of the motion vector input from the motion vector estimation unit 3. The addition unit 52 adds the warp image to the current frame using, for example, the following Formula (10) to generate a processing image.

$$\begin{matrix}I \left(i , {X}_{s}\right) = α I \left(i , {X}_{s}\right) + \left(1 - α\right) I \left(i - 1 , {X}_{s}\right) \\ I \left(i , {X}_{s}\right) : \text{addition} \text{image} \text{at} \text{pixel} \text{position} {X}_{s} \text{in} \text{ith} \text{frame,} \text{and} \\ α \text{I} \left(i , {X}_{s}\right) : \text{input} \text{image} \text{at} \text{pixel} \text{position} {X}_{s} \text{in} \text{ith} \text{frame}\end{matrix}$$

The warp image creation unit 53 outputs the generated processing image to the buffer memory. The processing image is used for addition in the next frame.

In the warp image creation unit 53, density may occur in pixel intervals due to the influence of parallax at the time of creating the warp image. For this reason, the warp reliability calculation unit 54 calculates the reliability according to the density of the pixels and outputs the reliability to the reliability calculation unit 51.

The reliability calculation unit 51 integrates the reliability input from the warp reliability calculation unit 54 and the reliability input from the occlusion prediction reliability calculation unit 43, and outputs the integrated reliability to the addition coefficient determination unit 55. The reliability calculation unit 51 calculates the reliability of the position of the subject in the image behind the foreground according to the elapsed time after the subject 101 is hidden behind the foreground. For example, the reliability calculation unit 51 calculates lower reliability as the elapsed time after the subject 101 is hidden behind the foreground is longer. In a case where the addition unit 52 performs multi-frame addition, the addition coefficient determination unit 55 determines an addition coefficient of an image to be used and outputs the addition coefficient to the addition unit 52. Note that the value of the reliability may be determined by learning in advance.

On the basis of the addition coefficient input from the addition coefficient determination unit 55, the addition unit 52 performs frame addition of a plurality of images at a ratio corresponding to the reliability calculated by the reliability calculation unit 51 to restore the images. The addition unit 52 performs frame addition by increasing the addition ratio for an image with higher reliability.

### APPLICATION EXAMPLE AND EFFECTS OF INFORMATION PROCESSING DEVICE

As described above, the information processing device 1 can realize performance improvement in a plurality of image processing technologies by adding multi-frames using motion vectors. For example, the information processing device 1 can realize performance improvement of noise removal technology, super-resolution technology, rain removal technology, and high dynamic range technology.

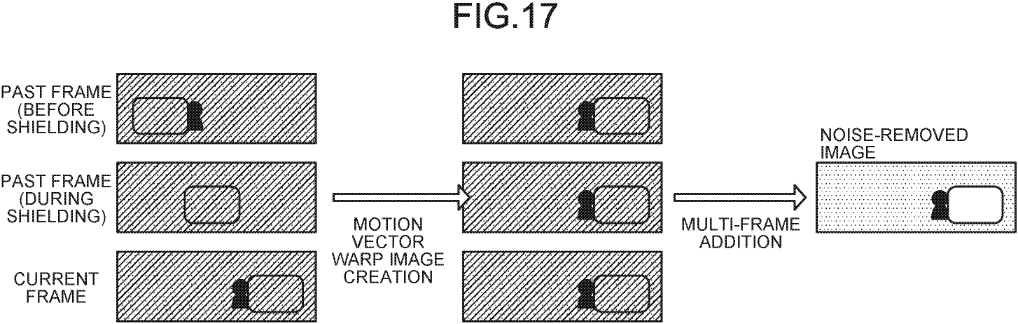

FIG. 17 is an explanatory diagram of a usage example of multi-frame addition according to the present disclosure. As illustrated in FIG. 17, according to the information processing device 1, it is possible to create a warp image to the current frame even for the subject shielded by the foreground in the past frame. As a result, the information processing device 1 can obtain a processing image from which noise has been removed by adding a warp image without image quality degradation such as blurring.

In addition, the information processing device 1 can execute the above-described processing in real time on a device such as a camera by reducing the processing cost using the frame memory.

In addition, the information processing device 1 predicts the movement of the subject in the occlusion unit, improving robustness with respect to the occlusion unit, and thus, it is possible to prevent occurrence of a double image due to multi-frame addition.

In addition, the information processing device 1 holds information of the background image in the occlusion unit over multi-frames, in a manner that it is possible to perform multi-frame addition also around the occlusion unit. In addition, the information processing device 1 can also cope with occlusion caused by a motion subject.

In addition, the information processing device 1 can estimate the distance to the subject simultaneously with the estimation of the motion vector of the subject in the image. The highly accurate distance information estimated by the information processing device 1 is useful in that it can be applied to a plurality of image processing technologies. For example, highly accurate distance information estimated by the information processing device 1 can be applied to a fog removal technique, a background blurring technique, and an autofocus technique.

In addition, even in a device in which it is difficult to add the distance sensor 112 or the stereo camera, the information processing device 1 can measure the distance to the subject as long as at least the monocular imaging device 100 and a sensor capable of measuring motion information of the imaging sensor 110 such as the IMU are provided.

In addition, the information processing device 1 holds information of the background image in the occlusion unit over multi-frames. Therefore, distance measurement performance improvement by multi-frame addition can be realized also around the occlusion unit.

Note that the effects described in the present specification are merely examples and are not limited, and other effects may be provided.

Note that the present technology can also have the configuration below.
(1) An information processing device including:
   a prediction unit that predicts, in a case where a subject in an image captured in time series by an imaging device is hidden behind a foreground, a position of the subject in the image behind the foreground on a basis of the image and motion information of the imaging device detected by a motion detection device.
(2) The information processing device according to (1), wherein
   the prediction unit
   uses a compressed image to predict the position of the subject in the image behind the foreground.
(3) The information processing device according to (1) including:
   a detection unit that detects the position of the subject in the image from the image; and
   an estimation unit that estimates a motion vector of the subject behind the foreground on a basis of a position of the subject in the image before being hidden behind the foreground and motion information of the imaging device detected by the motion detection device, wherein
   the prediction unit
   predicts the position of the subject in the image behind the foreground on a basis of the motion vector estimated by the estimation unit.
(4) The information processing device according to (3), wherein
   the estimation unit
   estimates a distance from the imaging device to the subject on a basis of the motion vector, and
   the prediction unit
   predicts the position of the subject in the image behind the foreground on a basis of the distance estimated by the estimation unit.
(5) The information processing device according to (4), wherein
   the detection unit
   detects the position of the subject in the image appearing from behind the foreground on a basis of the distance estimated by the estimation unit and the motion information of the imaging device detected by the motion detection device.
(6) The information processing device according to (3), wherein
   the estimation unit
   estimates, in a case where the subject is not hidden behind the foreground, a motion vector of the subject to be estimated on a basis of the motion information of the imaging device and a motion vector of the subject to be estimated on a basis of the image captured in time series, and
   the prediction unit
   predicts, in a case where an angle formed by a direction of a motion vector based on the motion information and a direction of a motion vector based on the image exceeds a threshold value, the position of the subject in the image behind the foreground on a basis of the motion vector based on the image.
(7) The information processing device according to (1) including:
   a reliability calculation unit that calculates reliability of the position of the subject in the image behind the foreground according to an elapsed time after the subject is hidden behind the foreground; and
   a restoration unit that restores the image by adding frames of a plurality of the images according to a ratio corresponding to the reliability calculated by the reliability calculation unit.
(8) An information processing method, wherein
   an information processing device
   executes a processing of predicting, in a case where a subject in an image captured in time series by an imaging device is hidden behind a foreground, a position of the subject in the image behind the foreground on a basis of the image and motion information of the imaging device detected by a motion detection device.
(9) An information processing program that causes
   an information processing device to execute a processing of
   predicting, in a case where a subject in an image captured in time series by an imaging device is hidden behind a foreground, a position of the subject in the image behind the foreground on a basis of the image and motion information of the imaging device detected by a motion detection device.

| | Reference Signs List |
|---|---|
| 1 | INFORMATION PROCESSING DEVICE |
| 2 | SEARCH RANGE DETERMINATION UNIT |
| 21 | MOTION SUBJECT DETECTION UNIT |
| 22 | OCCLUSION EXPOSURE DETECTION UNIT |
| 3 | MOTION VECTOR ESTIMATION UNIT |
| 31 | OCCLUSION SHIELDING DETECTION UNIT |
| 4 | OCCLUSION PREDICTION UNIT |
| 5 | HIGH-ACCURACY RESTORATION UNIT |
| 51 | RELIABILITY CALCULATION UNIT |
| 52 | ADDITION UNIT |

1. An information processing device comprising:
a prediction unit that predicts, in a case where a subject in an image captured in time series by an imaging device is hidden behind a foreground, a position of the subject in the image behind the foreground on a basis of the image and motion information of the imaging device detected by a motion detection device.

2. The information processing device according to claim 1, wherein
the prediction unit
uses a compressed image to predict the position of the subject in the image behind the foreground.

3. The information processing device according to claim 1 comprising:
a detection unit that detects the position of the subject in the image from the image; and
an estimation unit that estimates a motion vector of the subject behind the foreground on a basis of a position of the subject in the image before being hidden behind the foreground and motion information of the imaging device detected by the motion detection device, wherein
the prediction unit
predicts the position of the subject in the image behind the foreground on a basis of the motion vector estimated by the estimation unit.

4. The information processing device according to claim 3, wherein
the estimation unit
estimates a distance from the imaging device to the subject on a basis of the motion vector, and the prediction unit
predicts the position of the subject in the image behind the foreground on a basis of the distance estimated by the estimation unit.

5. The information processing device according to claim 4, wherein
the detection unit
detects the position of the subject in the image appearing from behind the foreground on a basis of the distance estimated by the estimation unit and the motion information of the imaging device detected by the motion detection device.

6. The information processing device according to claim 3, wherein
the estimation unit
estimates, in a case where the subject is not hidden behind the foreground, a motion vector of the subject to be estimated on a basis of the motion information of the imaging device and a motion vector of the subject to be estimated on a basis of the image captured in time series, and
the prediction unit
predicts, in a case where an angle formed by a direction of a motion vector based on the motion information and a direction of a motion vector based on the image exceeds a threshold value, the position of the subject in the image behind the foreground on a basis of the motion vector based on the image.

7. The information processing device according to claim 1 comprising:
a reliability calculation unit that calculates reliability of the position of the subject in the image behind the foreground according to an elapsed time after the subject is hidden behind the foreground; and
a restoration unit that restores the image by adding frames of a plurality of the images according to a ratio corresponding to the reliability calculated by the reliability calculation unit.

8. An information processing method, wherein
an information processing device
executes a processing of predicting, in a case where a subject in an image captured in time series by an imaging device is hidden behind a foreground, a position of the subject in the image behind the foreground on a basis of the image and motion information of the imaging device detected by a motion detection device.

9. An information processing program that causes
an information processing device to execute a processing of
predicting, in a case where a subject in an image captured in time series by an imaging device is hidden behind a foreground, a position of the subject in the image behind the foreground on a basis of the image and motion information of the imaging device detected by a motion detection device.
